(19) United States
(12) Patent Application Publication
(10) Pub. No.: US 2025/0031286 A1
(43) Pub. Date: Jan. 23, 2025

(54) COOKING APPARATUS

(71) Applicant: SAMSUNG ELECTRONICS CO., LTD., Suwon-si (KR)

(72) Inventors: Hongjoo KANG, Suwon-si (KR); Eundae BAE, Suwon-si (KR); YoungHoon WOO, Suwon-si (KR)

(73) Assignee: SAMSUNG ELECTRONICS CO., LTD., Suwon-si (KR)

(21) Appl. No.: 18/906,405

(22) Filed: Oct. 4, 2024

Related U.S. Application Data
(63) Continuation of application No. PCT/KR2023/004514, filed on Apr. 4, 2023.

(30) Foreign Application Priority Data
May 18, 2022 (KR) 10-2022-0060872
Sep. 8, 2022 (KR) 10-2022-0114537

(51) Int. Cl. H05B 6/12

(52) U.S. Cl. CPC H05B 6/1254; H05B 6/1272

(57) ABSTRACT

A cooking apparatus comprising a cooking plate; at least one coil assembly to generate a magnetic field; and a driving circuit to drive the at least one coil assembly. The at least one coil assembly includes a base; and a working coil supportable by the base. The working coil is formed of a wire. The wire is withdrawable toward the base.

### CROSS-REFERENCE TO RELATED APPLICATIONS

This application is a continuation application of International Application No. PCT/KR2023/004514, filed Apr. 4, 2023, in the Korean Intellectual Property Receiving Office, which claims priority from Korean Patent Application No. 10-2022-0060872, filed May 18, 2022 and Korean Patent Application No. 10-2022-0114537, Sep. 8, 2022, in the Korean Intellectual Property Office, the disclosures of which are hereby incorporated by reference herein in their entireties.

### TECHNICAL FIELD

The present disclosure relates to a cooking apparatus having an improved structure.

### BACKGROUND ART

As an example of cooking apparatuses, an induction heating apparatus cooks food by heating using the principle of induction heating. An induction heating apparatus includes a cooking plate on which a cooking vessel is placed and a working coil configured to generate a magnetic field by a current supplied thereto.

In the case where a current is supplied to a working coil to generate a magnetic field, a secondary current is induced in a cooking vessel, resulting in generation of Joule heat by resistance components of the cooking vessel. Therefore, a high-frequency current heats the cooking vessel, and food contained in the cooking vessel is cooked.

Because the cooking vessel itself is used as a heating source, such an induction heating apparatus has higher heat transfer rates, does not generate harmful gases, and has no risk of fire, compared to gas ranges or furnaces using kerosene that heats cooking vessels by using combustion heat obtained by burning fossil fuels.

### DISCLOSURE

### Technical Problem

Provided is a cooking apparatus in which a wire is easily withdrawn.

Provided is a cooking apparatus in which wire interference between wires of a plurality of working coils are inhibited.

Provided is a cooking apparatus in which a cooking area is easily obtained.

However, the technical problems to be solved by the present disclosure are not limited to the aforementioned problems, and any other technical problems not mentioned herein will be clearly understood from the following description by those skilled in the art to which the present invention pertains.

### Technical Solution

In accordance with an aspect of the present disclosure, a cooking apparatus includes: a cooking plate; at least one coil assembly, arrangeable below the cooking plate, configured to generate a magnetic field; and a driving circuit configured to drive the at least one coil assembly. The at least one coil assembly may include: a base; and a working coil supportable by the base. The working coil may be formed of a wire and the wire may be withdrawable toward the base. The base may have a rectangular shape and the wire is wound to correspond to the rectangular shape of the base and the wire is withdrawable toward a corner of the base.

The wire may include a plurality of windings constituting respective turns. The base may include a first opening adjacent to an innermost turn of the wire while the working coil is supported by the base. The base may include a second opening adjacent to an outermost turn of the wire while the working coil is supported by the base and formed at one corner of the base.

The wire may pass through the first opening of the base to be wound on a top surface of the base and pass through the second opening of the base to be connected to the driving circuit.

The second opening may be formed at each corner of the base.

The base may include a base body on which the working coil is seated so as to be supported by the base. The base may include a first coupler formed both at a first side of the base body and a second side of the base body perpendicular to the first side; and a second coupler formed both at a third side of the base body facing the first side and a fourth side of the base body facing the second side.

The at least one coil assembly may be a first coil assembly and the cooking apparatus includes a second coil assembly arrangeable adjacent to the first coil assembly. The first coupler of the first coil assembly may be coupleable to the second coupler of the second coil assembly.

The at least one coil assembly may be a first coil assembly and the cooking apparatus includes a second coil assembly arrangeable adjacent to the first coil assembly. The second coupler of the first coil assembly may be coupleable to the first coupler of the second coil assembly.

The first coupler may include a coupling hole. The second coupler may include a coupling protrusion insertable into the coupling hole.

The wire may include: a first wire section below of the base and extending toward the first opening; and a second wire section extending from the first wire section and passing through the first opening to be supported by the base. The base may further include a guide groove radially formed on a bottom surface of the base to guide the first wire section.

The base may further include a holder disposed adjacent to the guide groove and provided to fix the first wire section.

The at least one coil assembly may be among a plurality of coil assemblies, the plurality of coil assemblies may include a first coil assembly, a second coil assembly coupleable to the first coil assembly in a first direction, a third coil assembly coupleable to the first coil assembly in a second direction, a fourth coil assembly coupleable to the second coil assembly in the second direction and coupled to the third coil assembly in the first direction. The wire of the first coil assembly may be withdrawn via a corner facing the fourth coil assembly. The wire of the second coil assembly may be withdrawn via a corner facing the third coil assembly. The wire of the third coil assembly may be withdrawn via a corner facing the second coil assembly. The wire of the fourth coil assembly may be withdrawn via a corner facing the first coil assembly.

Each corner of the base may have an arc shape.

The wire may form a plurality of windings constituting respective turns. The base may include: a base body on which the working coil is seated. The base may include a plurality of ribs protruding upward from the base body and extending along edges of the base body to separate the plurality of windings from each other. The base may include a plurality of grooves formed between adjacent ribs among the plurality of ribs.

The cooking apparatus may further include a ferrite mountable under a bottom of the base to increase a density of the magnetic field generated by the working coil.

The at least one coil assembly may further include a sheet arrangeable above the working coil, having a shape corresponding to the base, and formed of an electrically insulating material.

A cooking apparatus according to an embodiment may include: a housing; a cooking plate coupleable to the top of the housing on which a cooking vessel is placed; and a plurality of coil assemblies to be accommodated in the housing, configured to perform induction heating on the cooking vessel, and each coil assembly including wires wound to have a rectangular shape. The plurality of coil assemblies may include a first coil assembly, a second coil assembly disposed in a first direction with the first coil assembly, a third coil assembly disposed in a second direction with the first coil assembly, and a fourth coil assembly disposed in the second direction with the second coil assembly and disposed in the first direction with the third coil assembly. The wire of the first coil assembly may be withdrawn via a corner facing the fourth coil assembly. The wire of the second coil assembly may be withdrawn via a corner facing the third coil assembly. The wire of the third coil assembly may be withdrawn via a corner facing the second coil assembly. The fourth coil assembly may be withdrawn via a corner facing the first coil assembly.

The cooking apparatus may further include a printed board assembly provided to drive and control the plurality of coil assemblies. The cooking apparatus may be disposed between the plurality of coil assemblies and the printed board assembly and may further include a partition including a magnetic field shielding material.

The partition may further include a partition hole formed to guide each wire of the plurality of coil assemblies to the printed board assembly.

The plurality of coil assemblies may further include a communicating portion surrounded by the first coil assembly, the second coil assembly, the third coil assembly, and the fourth coil assembly. The wire of the first coil assembly, the wire of the second coil assembly, the wire of the third coil assembly, and the wire of the fourth coil assembly may be provided to pass through the communicating portion.

The coil assembly according to an embodiment may include a working coil formed of wound wire; and a base provided to support the working coil. The base may include a base body with a rectangular shape on which the working coil is mounted. The base may include a corner body protruding from each corner of the base body. The base may have an opening through which the wire of the working coil is withdrawn as an opening penetrating the corner body.

### Advantageous Effects

According to an aspect of the present disclosure, a wire is easily withdrawn in the cooking apparatus.

According to an aspect of the present disclosure, wire interference between a plurality of working coils may be prevented in the cooking apparatus.

According to an aspect of the present disclosure, the cooking apparatus may obtain a cooking area maximized by reducing gaps between adjacent working coils.

However, the effects obtainable by the present disclosure are not limited to the aforementioned effects, and any other effects not mentioned herein will be clearly understood from the following description by those skilled in the art to which the present disclosure pertains.

### DESCRIPTION OF DRAWINGS

FIG. 1 is a perspective view exemplarily illustrating a cooking apparatus according to an embodiment.

FIG. 2 is an exploded view of a cooking apparatus according to an embodiment.

FIG. 3 is a view illustrating a principle of heating a cooking vessel by a cooking apparatus according to an embodiment.

FIG. 4 is a control block diagram of a cooking apparatus according to an embodiment.

FIG. 5 shows a printed board assembly (PBA) of a cooking apparatus according to an embodiment.

FIG. 6 shows an example of a cooking apparatus according to an embodiment.

FIG. 7 is an exploded view exemplarily illustrating a coil assembly according to an embodiment.

FIG. 8 is a bottom perspective view exemplarily illustrating a coil assembly according to an embodiment.

FIG. 9 is a perspective view exemplarily illustrating a base according to an embodiment.

FIG. 10 is a perspective view illustrating an example of a plurality of coil assemblies according to an embodiment.

FIG. 11 is a plan view of an example of a plurality of coil assemblies according to an embodiment.

FIG. 12 is a partially exploded view of FIG. 11 according to an embodiment.

### BEST MODE

The embodiments described in the specification and shown in the drawings are only illustrative and are not intended to represent all aspects of the invention, such that various equivalents and modifications may be made without departing from the spirit of the invention.

Like reference numerals denote like elements or components having substantially same functions in the drawings.

Also, the terms used herein are merely used to describe particular embodiments, and are not intended to limit the present disclosure. An expression used in the singular encompasses the expression of the plural, unless otherwise indicated. Throughout the specification, the terms such as “including” or “having” are intended to indicate the existence of features, numbers, operations, components, parts, or combinations thereof disclosed in the specification, and are not intended to preclude the possibility that one or more other features, numbers, operations, components, parts, or combinations thereof may exist or may be added.

Throughout the specification, when an element is referred to as being “connected to” another element, the element may be directly connected to the other element, or the element may also be indirectly connected to the other element. In the same manner, when an element is referred to as being “coupled to” another element, the element may be directly coupled to the other element, or the element may also be indirectly coupled to the other element.

Throughout the specification, it will be understood that when one element, is referred to as being “on” another element, it can be directly on the other element, or intervening elements may also be present therebetween.

It will be understood that, although the terms “first”, “second”, etc., may be used herein to describe various elements, these elements should not be limited by these terms. The above terms are used only to distinguish one component from another. For example, a first component discussed below could be termed a second component, and similarly, the second component may be termed the first component without departing from the teachings of this disclosure.

Throughout the disclosure, the expressions “A or B”, “at least one of A and B”, “at least one of A or B”, “A, B or C”, “at least one of A, B, and C”, and “at least one of A, B, or C” may include any one or all combinations of one or more the listed items.

As used herein, the term “and/or” includes any combinations of one or more of the associated listed items.

Meanwhile, the terms used in the following descriptions, e.g., “front-back direction”, “front side”, “rear side”, “left-right direction”, “left side”, “right side”, “upper-lower direction”, “upper side”, and “lower side” are defined based on the drawings, and the shape and position of each element is not limited thereby. For example, +X direction may be defined as front side, and −X direction may be defined as rear side. For example, +Y direction may be defined as right side, and −Y direction may be defined as left side. For example, +Z direction may be defined as upper side, and −Z direction may be defined as lower side.

Hereinafter, embodiments of the present disclosure will be described in detail with reference to the accompanying drawings.

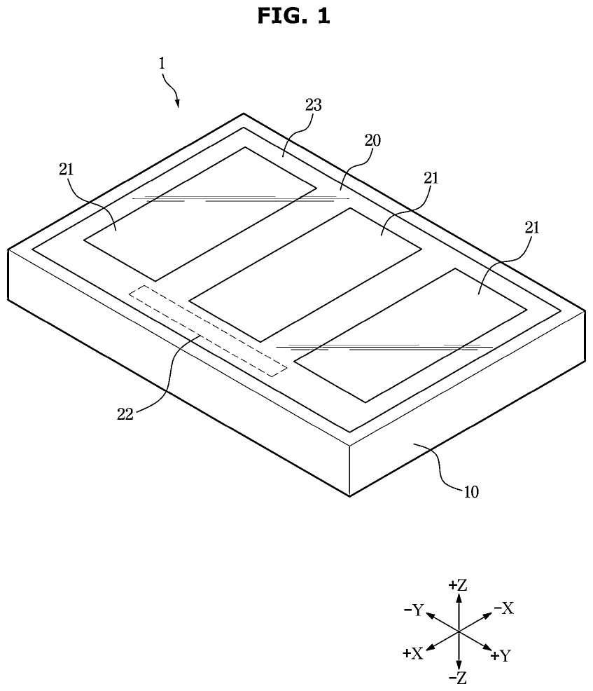

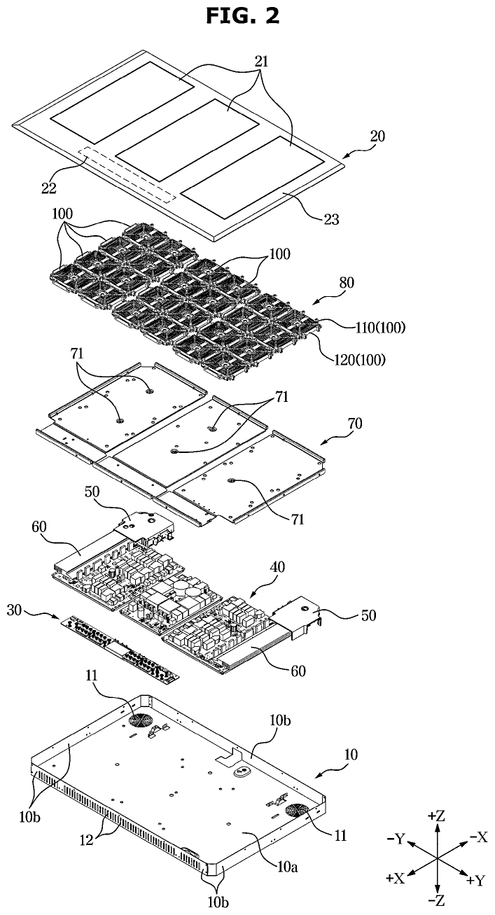

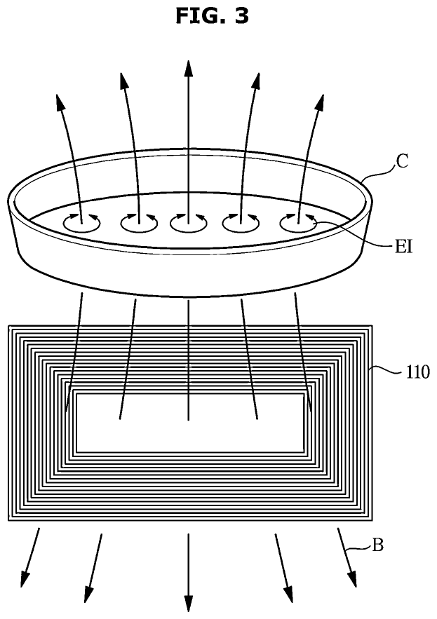

FIG. 1 is a perspective view exemplarily illustrating a cooking apparatus according to an embodiment. FIG. 2 is an exploded view of a cooking apparatus according to an embodiment. FIG. 3 is a view illustrating a principle of heating a cooking vessel by a cooking apparatus.

Referring to FIGS. 1 and 2, a cooking apparatus 1 may include a housing 10. The housing 10 may accommodate various parts constituting the cooking apparatus 1. The housing 10 may define an external appearance of at least a part of the cooking apparatus 1. For example, the housing 10 may have a shape with an open top. The housing 10 may also be referred to as case 10.

The cooking apparatus 1 may include a cooking plate 20 on which a cooking vessel C (See FIG. 3) is placed. The cooking plate 20 may be coupled to the top of the housing 10. For example, the cooking plate 20 may have an approximately flat-panel shape. For example, the cooking plate 20 may include tempered glass such as ceramic glass to prevent the cooking plate 20 from easily breaking.

The cooking plate 20 may include a first area 21. The first area 21 may correspond to a position of at least one working coil 110 which will be described below. The first area 21 may be an area where the cooking vessel C is placed.

For example, a guide mark informing a user of a position capable of heating a cooking vessel may be formed in the first area 21. Although three first areas 21 are shown in FIGS. 1 and 2, the embodiment is not limited thereto, The number of the first area 21 may be 1 or equal to or more than 4.

For example, the guide mark may be provided to have a shape corresponding to the shape of the working coil 110.

The cooking plate 20 may include a second area 22. The second area 22 may be provided to receive a control command from the user. The second area 22 may be provided to display information on the operation of the cooking apparatus 1 to the user. The second area 22 may be provided as an example of a user interface.

Although the second area 22 provided at a front region of the cooking plate 20 is shown in FIGS. 1 and 2, the embodiment is not limited thereto. Although a second area 22 having a rectangular shape is illustrated in FIGS. 1 and 2, the embodiment is not limited thereto. The position and shape of the second area 22 is not limited as long as the second area 22 receives a command from the user and displays a status of the cooking apparatus.

The cooking plate 20 may include a third area 23. The third area 23 may be an area excluding the first area 21 and the second area 22 from the entire area of the cooking plate 20.

Referring to FIG. 2, the cooking apparatus 1 may include at least one coil assembly 100 disposed below the cooking plate 20. For example, the cooking apparatus 1 may include a heater 80 consisting of at least one coil assembly 100. The heater 80 may be provided to heat a cooking vessel C placed on the cooking plate 20. The heater 80 may form at least one cooking zone. At least one coil assembly 100 may be referred to as heater 80. The heater 80 may also be referred to as a heating device 80.

Although 24 coil assemblies 100 are shown in FIG. 2, the number of the coil assembly 100 is not limited thereto. One coil assembly 100 may be provided. The coil assembly 100 may be provided in a plural number of two or more. In addition, although four adjacent coil assemblies 100 combined to constitute one heating unit are shown in FIG. 2, the number of the coil assemblies 100 constituting one heating unit is not limited. One coil assembly 100 may constitute one heating unit. Two or more coil assemblies 100 may constitute one heating unit.

The coil assembly 100 may include a working coil 110 capable of generating a magnetic field and/or electromagnetic field. The coil assembly 100 may include a base 120 supporting the working coil 110. This will be described below in more detail.

The cooking apparatus 1 may include a main assembly 30 provided to implement a user interface.

For example, the main assembly 30 may be a printed board assembly (PBA) including a display, a switching device, an integrated circuit element, and a printed circuit board (PCB) provided therewith.

The main assembly 30 may be disposed to correspond to the second area 22. The main assembly 30 may be accommodated in the housing 10. The main assembly 30 may be disposed below the cooking plate 20. The main assembly 30 may be disposed below the coil assembly 100. The main assembly 30 may be disposed below the heater 80.

The cooking apparatus 1 may include a printed board assembly (PBA) 40. The printed board assembly 40 may be provided to supply a driving current to at least one coil assembly 100. The printed board assembly 40 may be provided to implement a circuit for operation of the at least one coil assembly 100. The printed board assembly 40 may include various devices and/or circuits to supply a driving current to the at least one coil assembly 100. This will be described below in more detail.

The cooking apparatus 1 may include a fan 50. The fan 50 may be provided to dissipate heat from the inside the housing 10. The fan 50 may be provided to lower temperature of the printed board assembly 40 and/or the main assembly 30. The fan 50 may intake external air. The fan 50 may discharge air flowing in the housing 10. That is, external air introduced into the housing 10 by the fan 50 may cool the inside of the housing 10 and then be discharged out of the housing 10.

At least one fan 50 may be provided. Although two fans 50 are shown in the drawings, the embodiment is not limited thereto. For example, one fan 50 may be provided. For example, the fan 50 may be provided in a plural number of 3 or more.

For example, an axial fan or a mixed-flow fan may be applied to the fan 50. However, the type of the fan 50 is not limited thereto, and the fan 50 may have any configuration as long as air outside the housing 10 is introduced and air inside the housing 10 is discharged out of the housing 10.

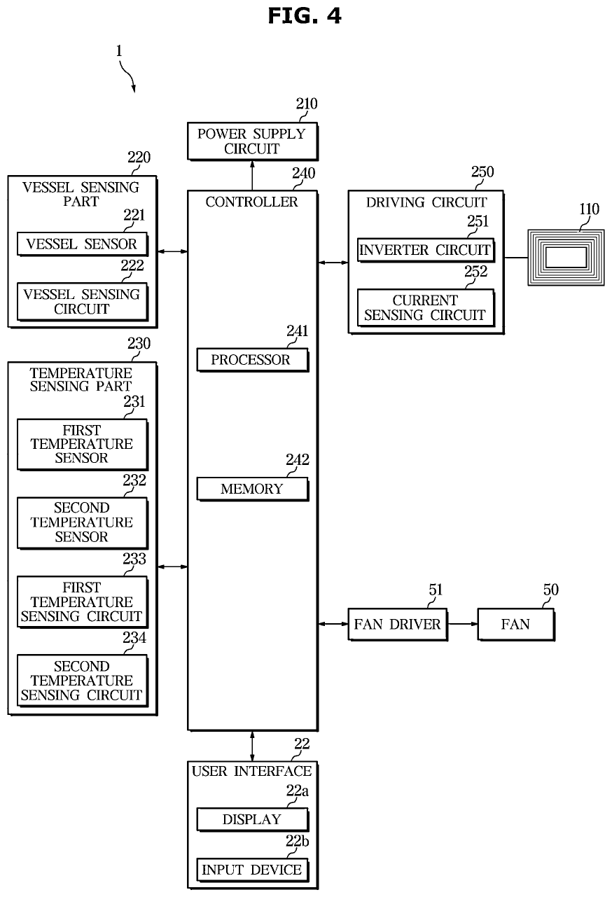

The cooking apparatus may include a fan driver 51 (See FIG. 4) configured to drive the fan 50. For example, the fan driver 51 may include a motor provided to rotate the fan 50. However, the embodiment is not limited thereto, and the fan driver 51 may have any configuration for driving the fan 50.

The housing 10 may include an inlet 11. The fan 50 may intake external cool air into the housing 10 through the inlet 11. For example, the inlet 11 may be formed at the bottom surface 10a of the housing 10. However, the position of the inlet 11 is not limited thereto and may vary according to the shape and arrangement of the fan 50.

The housing 10 may include an outlet 12. The fan 50 may discharge hot air inside the housing 10 out of the housing 10 through the outlet 12. For example, the outlet 12 may be formed at a side surface 10b of the housing 10. However, the position of the outlet 12 is not limited thereto and may vary according to the shape and arrangement of the fan 50.

The cooking apparatus 1 may include a heat sink 60. The heat sink 60 may be configured to dissipate heat from the inside the housing 10. The heat sink 60 may be provided to lower temperature of the printed board assembly 40 and/or the main assembly 30.

For example, the heat sink 60 may be provided at the printed board assembly 40 to prevent heat generation in a rectifier circuit 270 or a driving circuit 250. The heat sink 60 may be provided to be in contact with at least one of the rectifier circuit 270 or the driving circuit 250 of the printed board assembly 40. However, these are merely examples and the position of the heat sink 60 is not limited thereto.

At least one heat sink 60 may be provided. Although two heat sinks 60 are illustrated in the drawings, the embodiment is not limited thereto. For example, one heat sink 60 may be provided. For example, the heat sink 60 may be provided in a plural number of 3 or more.

For example, the heat sink 60 may include a material with high thermal conductivity. For example, the heat sink 60 may include at least one of aluminum or copper.

The cooking apparatus 1 may include a partition 70. The partition 70 may be provided between a cooking assembly 20 and the bottom surface 10a of the housing 10. The partition 70 may be disposed between the at least one coil assembly 100 and the printed board assembly 40. The partition 70 may be disposed between the heater 80 and the printed board assembly 40.

The partition 70 may be provided to support the at least one coil assembly 100. The partition 70 may be disposed to correspond to the at least one coil assembly 100. For example, the partition 70 may have an approximately flat-panel shape.

The partition 70 may include a magnetic shielding material. The partition 70 may prevent an induced magnetic field generated in the working coil 110 from leaking to the printed board assembly 40 and/or the main assembly 30. Therefore, the printed board assembly 40 and/or the main assembly 30 may be provided not to be affected by the induced magnetic field by using the partition 70.

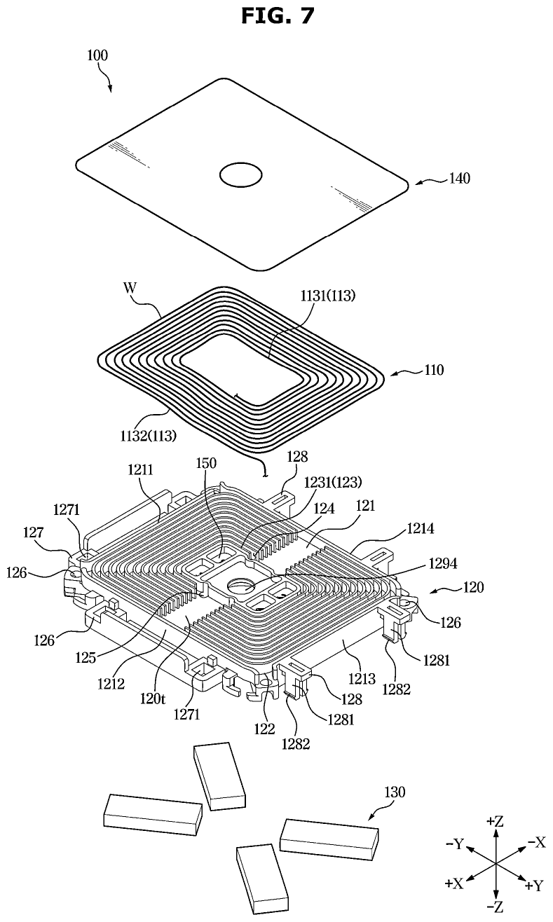

The partition 70 may have a partition hole 71. The partition hole 71 may be formed to guide the wire W of the working coil 110 (See FIG. 7) of the at least one coil assembly 100 to the printed board assembly 40. Opposite ends of the wire W may pass through the partition hole 71 to be connected to the printed board assembly 40.

In the case where the coil assembly 100 is provided in a plural number, the partition hole 71 may be provided to guide each of the wires of the plurality of coil assemblies 100 to the printed board assembly 40.

For example, at least one partition hole 71 may be provided.

Referring to FIG. 3, the principle of heating the cooking vessel C will be described.

For example, when a driving current is supplied to the working coil 110, as shown in FIG. 3, a magnetic field B may be induced around the working coil 110.

When a current whose magnitude and direction vary over time, i.e., alternating current, is supplied to the working coil 110, a magnetic field B whose intensity and direction vary over time may be induced around the working coil 110.

The magnetic field B around the working coil 110 may pass through the cooking plate 20 to arrive at the cooking vessel C placed on the cooking plate 20.

An eddy current EI that rotates about the magnetic field B may be generated in the cooking vessel C due to the magnetic field B whose intensity and direction vary over time. As such, a phenomenon in which an eddy current is generated by the magnetic field B varying over time may be referred to as an electromagnetic induction phenomenon. Due to the eddy current EI, electrical resistance heat may be generated in the cooking vessel C. The electrical resistance heat is heat generated in a resistor in the case where a current flows in the resistor and is also referred to as Joule heat. The cooking vessel C is heated by the electrical resistance heat and food contained in the cooking vessel C may be heated thereby.

As described above, the working coil 110 may heat the cooking vessel C by using the electromagnetic induction phenomenon and electrical resistance heat.

FIG. 4 is a control block diagram of a cooking apparatus according to an embodiment.

Referring to FIG. 4, the cooking apparatus 1 may include a power supply circuit 210. The power supply circuit 210 may be provided to receive AC power from an external power source. The power supply circuit 210 may be provided to supply the received AC power to the driving circuit 250. For example, the power supply circuit 210 may be installed on the printed board assembly 40.

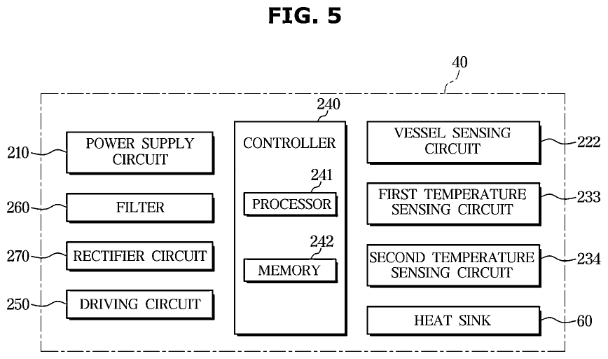

For example, the power supply circuit 210 may convert the received external AC power into 3-phase AC power. For example, the converted AC power may be supplied to the driving circuit 250 through a filter (See FIG. 5) and a rectifier circuit 270 (See FIG. 5).

The cooking apparatus 1 may include a vessel sensing device 220. The vessel sensing device 220 may be provided to detect the cooking vessel C placed on the cooking plate 20.

For example, the vessel sensing device 220 may include a vessel sensor 221 configured to detect a position of the cooking vessel C. The vessel sensing device 220 may include a vessel sensing circuit 222 configured to process an output of the vessel sensor 221 and output information on the position of the cooking vessel C to a controller 240.

The vessel sensor 221 may be located adjacent to the working coil 110 and detect the cooking vessel C disposed above the working coil 110. For example, the vessel sensor 221 may be located at the center of a base 120 of a coil assembly 100 which will be described later. For example, the vessel sensor 221 may be detachably mounted on a sensor mount 1294 of the base 120 of the coil assembly 100 which will be described later. However, the position of the vessel sensor 221 is not limited as long as the vessel sensor 221 may detect the position of the cooking vessel C.

For example, the vessel sensor 221 may include a capacitive sensor to detect the cooking vessel C. The vessel sensor 221 may detect variation in capacitance by the cooking vessel C. However, the vessel sensor 221 is not limited to the capacitive sensor and may include various sensors capable of detect the cooking vessel C placed on the cooking plate 20 such as an infrared sensor, a weight sensor, a microswitch, and a membrane switch.

The vessel sensor 221 may output information on detection of the cooking vessel C to the vessel sensing circuit 222.

The vessel sensing circuit 222 may receive a detection result of the cooking vessel C from the vessel sensor 221 and determine the position of the cooking vessel C in accordance with the detection result. For example, the vessel sensing circuit 222 may determine the working coil 110 overlapping the cooking vessel C. For example, the vessel sensing circuit 222 may be installed on the printed board assembly 40.

For example, the vessel sensing circuit 222 may include a multiplexer to sequentially receive detection results from the vessel sensor 221. For example, the vessel sensing circuit 222 may include a microprocessor to process the detection results of the vessel sensor 221.

The vessel sensing circuit 222 may output vessel position data obtained by processing the detection results of the vessel sensor 221 to the controller 240.

The controller 240 may control a user interface 22 to display the position of the cooking vessel C based on the detection results of the vessel sensing device 220. The controller 240 may control the driving circuit 250 corresponding to the working coil 110 to supply a driving current to the working coil 110 overlapping the cooking vessel C.

Meanwhile, the vessel sensing device 220 may be omitted, and in this case, the controller 240 may directly determine the working coil 110 overlapping the cooking vessel C. For example, the controller 240 may determine the working coil 110 overlapping the cooking vessel C based on variation in inductance of the working coil 110 by an approach of the cooking vessel C.

The controller 240 may control the driving circuit 250 to output a detection signal for detecting the cooking vessel C to the working coil 110 at predetermined intervals of time. In addition, the controller 240 may control a current sensing circuit 252 of the driving circuit 250 to detect a current flowing in the working coil 110 by the detection signal.

An inductance of the working coil 110 overlapping the cooking vessel C is different from that of the working coil 110 not occupied by the cooking vessel C. An AC current flowing in the working coil 110 overlapping the cooking vessel C is different from that of the working coil 110 not occupied by the cooking vessel C. The controller 240 may determine the working coil 110 overlapping the cooking vessel C by measuring the magnitude of the AC current flowing in the working coil 110 and comparing the measured magnitude of the current with that of a reference current.

However, the embodiment is not limited thereto, and the cooking apparatus 1 may determine the working coil 110 overlapping the cooking vessel C by measuring frequency, phase, and the like of the AC current flowing in the working coil 110.

The cooking apparatus 1 may include a temperature sensing device 230. The temperature sensing device 230 may be provided to sense temperature of the cooking vessel C placed on the cooking plate 20 or temperature of the heat sink 60.

The cooking vessel C may be overheated by the working coil 110. The cooking apparatus 1 may sense the temperature of the cooking vessel C placed on the cooking plate 20 and stop the operation of the working coil 110 upon determination that the cooking vessel C is overheated. Therefore, stability in use of the cooking apparatus 1 may be obtained.

For example, the temperature sensing device 230 may include a first temperature sensor 231 configured to sense the temperature of the cooking vessel C. For example, the temperature sensing device 230 may include a first temperature sensing circuit 233 configured to process the output of the first temperature sensor 231 and output information on the temperature of the cooking vessel C to the controller 240.

The first temperature sensor 231 may be disposed adjacent to the working coil 110 and measure the temperature of the cooking vessel C heated by the working coil 110. For example, the first temperature sensor 231 may be located at the center of the base 120 of the coil assembly 100 which will be described later. For example, the first temperature sensor 231 may be detachably mounted on the sensor mount 1294 of the base 120 of the coil assembly 100 which will be described later. However, the position of the first temperature sensor 231 is not limited as long as the first temperature sensor 231 may measure the temperature of the cooking vessel C.

For example, the first temperature sensor 231 may include a thermistor whose electrical resistance varies in accordance with temperature.

The first temperature sensor 231 may output a signal indicating the temperature of the cooking vessel C to the first temperature sensing circuit 233.

The first temperature sensing circuit 233 may receive a signal indicating the temperature of the cooking vessel C from the first temperature sensor 231 and determine the temperature of the cooking vessel C based on the received signal. For example, the first temperature sensing circuit 233 may be installed on the printed board assembly 40.

For example, the first temperature sensing circuit 233 may include a multiplexer to sequentially receive signals indicating temperature from the first temperature sensor 231. For example, the first temperature sensing circuit 233 may include an analog-digital converter (ADC) that converts the signal indicating temperature into digital temperature data.

The first temperature sensing circuit 233 may output temperature data obtained by processing sensing results of the first temperature sensor 231 to the controller 240.

The temperature sensing device 230 may sense the temperature of the cooking vessel C and output sensing results to the controller 240. The controller 240 may determine whether the cooking vessel C is overheated based on the sensing results of the temperature sensing device 230 and may stop heating of the cooking vessel C upon determination that the cooking vessel C is overheated.

The heat sink 60 may be overheated by dissipating heat generated by the printed board assembly 40. The cooking apparatus 1 may sense temperature of the heat sink 60 and stop the operation of the working coil 110 upon determination that the heat sink 60 is overheated. Therefore, stability in use of the cooking apparatus 1 may be obtained.

For example, the temperature sensing device 230 may include a second temperature sensor 232 configured to sense temperature of the heat sink 60. For example, the temperature sensing device 230 may include a second temperature sensing circuit 234 configured to process the output of the second temperature sensor 232 and output information on the temperature of the heat sink 60 to the controller 240.

The second temperature sensor 232 may be disposed adjacent to the heat sink 60 and measure the temperature of the heat sink 60. For example, the second temperature sensor 232 may include a thermistor whose electrical resistance varies in accordance with temperature.

The second temperature sensor 232 may output a signal indicating the temperature of the heat sink 60 to the second temperature sensing circuit 234.

The second temperature sensing circuit 234 may receive a signal indicating the temperature of the heat sink 60 from the second temperature sensor 232 and determine the temperature of the heat sink 60 based on the received signal. For example, the second temperature sensing circuit 234 may be installed on the printed board assembly 40.

For example, the second temperature sensing circuit 234 may include an analog-digital converter (ADC) that converts the signal indicating temperature into digital temperature data.

The second temperature sensing circuit 234 may output temperature data obtained by processing sensing results of the second temperature sensor 232 to the controller 240.

The temperature sensing device 230 may sense the temperature of the heat sink 60 and output sensing results to the controller 240. The controller 240 may determine whether the heat sink 60 is overheated based on the sensing results of the temperature sensing device 230 and may stop the operation of the working coil 110 upon determination that the heat sink 60 is overheated.

The cooking apparatus 1 may include the controller 240. The controller 240 may be provided to control the cooking apparatus 1 according to a user input. The controller 240 may be provided to control components of the cooking apparatus 1 according to the user input.

For example, the controller 240 may include at least one processor 241 and/or at least one memory 242.

For example, the at least one processor 241 may generate an output control signal to control the intensity of a magnetic field of the working coil 110 according to an output level received from a user via the user interface 22.

For example, the at least one processor 241 may determine whether the cooking vessel C is placed on the working coil 110 based on an output value received from at least one of the vessel sensing circuit 222 or the current sensing circuit 252.

For example, the at least one processor 241 may include various logic circuits and arithmetic circuits, and may perform data processing according to a program provided by the at least one memory 242 and generate a control signal based on the processed results.

For example, the at least one memory 242 may store a control program and control data to control the operation of the cooking apparatus 1. In addition, the at least one memory 242 may temporarily store a user input received from the user interface 22, position data of the cooking vessel C received from the vessel sensing device 220, temperature data of the cooking vessel C or the heat sink 310 received from the temperature sensing device 230, current values measured by the driving circuit 250, and the like.

For example, the at least one memory 242 may provide the at least one processor 241 with control programs and/or control data according to the control signal of the at least one processor 241. The at least one memory 242 may provide the at least one processor 241 with the user input, the position data of the cooking vessel C, and/or the temperature data of the cooking vessel C and the heat sink 310.

For example, the at least one memory 242 may include a volatile memory that temporarily stores data such as static random access memory (S-RAM) and dynamic random access memory (D-RAM) and a non-volatile memory that stores driving programs and/or driving data for a long time such as read only memory (ROM), erasable programmable read only memory (EPROM), electrically erasable programmable read only memory (EEPROM), and flash memory.

The at least one processor 241 and at least one memory 242 may be implemented as separate integrated circuits (ICs) or as one integrated circuit (IC).

The at least one processor 241 may be installed on the printed board assembly 40. The at least one memory 242 may be installed on the printed board assembly 40.

The cooking apparatus 1 may include the driving circuit 250. The driving circuit 250 may be provided to drive the at least one coil assembly 100. The driving circuit 250 may be provided to supply a driving current to the working coil 110. The cooking apparatus 1 may be electrically connected to the working coil 110 to supply a driving current to the connected working coil 110.

For example, the driving circuit 250 may be provided to correspond to the working coil 110. For example, at least one driving circuit 250 may be provided. For example, the number of the driving circuit 250 may be the same as that of the working coil 110.

The driving circuit 250 may be controlled by the controller 240. The driving circuit 250 may selectively supply a driving current to the working coil 110 under the control of the controller 240. The driving circuit 250 may be configured to receive power from the external power source and supply a current to the working coil 110 in accordance with the driving control signal of the controller 240. The driving circuit 250 may supply an AC driving current to the working coil 110 by using the power supplied via the power supply circuit 210 under the control of the controller 240. For example, the driving circuit 250 may be installed on the printed board assembly 40.

The driving circuit 250 may include an inverter circuit 251 that supplies or blocks the driving current to the working coil 110.

For example, the inverter circuit 251 may include at least one switching device. The inverter circuit 251 may change the magnitude and direction of the current supplied to the working coil 110 by controlling turning on/off of the at least one switching device under the control of the controller 240.

For example, the inverter circuit 251 may correspond to a half-bridge circuit that supplies a driving current to the working coil 110 by using two switching devices. For example, the inverter circuit 251 may correspond to a full-bridge circuit that supplies a driving current to the working coil 110 by using four switching devices.

For example, in the case where the inverter circuit 251 is a half-bridge circuit, a pair of switching devices may be connected in parallel with a pair of capacitors in the inverter circuit 251. In this regard, one end of the working coil 110 may be connected to a node connected in series with the pair of switching devices, and the other end of the working coil 110 may be connected to a node connected in series with the pair of the capacitors.

For example, in the case where the inverter circuit 251 is a full-bridge circuit, one pair of switching devices may be connected in parallel with another pair of switching devices in the inverter circuit 251. In this regard, one end of the working coil 110 may be connected to a node connected in series with the pair of switching devices, and the other end of the working coil 110 may be connected to a node connected in series with the pair of capacitors.

The driving circuit 250 may include the current sensing circuit 252 configured to measure a current output from the inverter circuit 251. The current sensing circuit 252 may measure the magnitude of the AC driving current supplied to the working coil 110.

The current sensing circuit 252 may include various circuits. For example, the current sensing circuit 252 may include a hall sensor to measure the intensity of a magnetic field generated around an electric wire that supplies a current to the working coil 110 and may calculate the magnitude of the current output from the inverter circuit 251 based on the intensity of the magnetic field measured by the hall sensor.

The cooking apparatus 1 may include the working coil 110. The working coil 110 may be disposed below the cooking plate 20 and generate a magnetic field and/or electromagnetic field for heating the cooking vessel C placed on the cooking plate 20. At least one working coil 110 may be provided, but the number thereof is not limited.

The working coil 110 may receive the driving current from the driving circuit 250.

The cooking apparatus 1 may include the user interface 22. The user interface 22 may receive an input from the user. The user interface 22 may display operation information of the cooking apparatus 1, a status of the cooking apparatus 1, various messages, and the like.

For example, the user interface 22 may include a display 22a to display the operating status of the cooking apparatus to the user. For example, the display 22a may be implemented by using a liquid crystal display (LCD), a light emitting diode (LED), an organic light emitting diode (OLED), or the like.

For example, the user interface 22 may include an input device 22b configured to receive various control commands from the user. For example, the input device 22b may be implemented by using various input devices such as physical buttons, touch buttons, touch pads, knobs, jog shuttles, control sticks, trackballs, and trac pads.

For example, the user interface 22 may include a touch screen panel (TSP) in which the display 22a and the input device 22b are integrated.

The cooking apparatus 1 may further include a communication module (not shown) connected to a network by wire or wirelessly and configured to communicate with other electronic devices, servers, and the like.

FIG. 5 shows a printed board assembly of a cooking apparatus according to an embodiment. Like reference numerals denote like elements or components having substantially same functions, and therefore repeated descriptions thereof will be omitted.

The printed board assembly 40 may include various elements to drive the cooking apparatus 1.

For example, as described above, the power supply circuit 210, the vessel sensing circuit 222, the first temperature sensing circuit 233, the second temperature sensing circuit 234, the controller 240, and the driving circuit 250 of the cooking apparatus 1 may be provided on the printed board assembly 40.

For example, a filter 260 may be installed at the printed board assembly 40. The filter 260 may block high-frequency noise included in the AC power received from the external power source via the power supply circuit 210 and transmit AC voltages and AC currents with predetermined frequencies.

The filter 260 may include an inductor and a capacitor disposed between an input and an output of the filter 260, and the inductor may block high-frequency noise and the capacitor may allow bypassing of the high-frequency noise to the external power source.

The filter 260 may include, according to embodiments, at least one of a common mode filter, a normal mode filter, an across the line capacitor (X-CAP), a line bypass capacitor (Y-CAP), and a varistor.

The AC power from which high-frequency noise is removed by the filter 260 may be supplied to the rectifier circuit 270.

For example, the rectifier circuit 270 may be installed at the printed board assembly 40. The rectifier circuit 270 may convert an AC voltage whose magnitude and polarity (positive voltage or negative voltage) change over time into a DC voltage with constant magnitude and polarity and may convert an AC current whose magnitude and direction (positive current or negative current) changes over time into a DC current with constant magnitude.

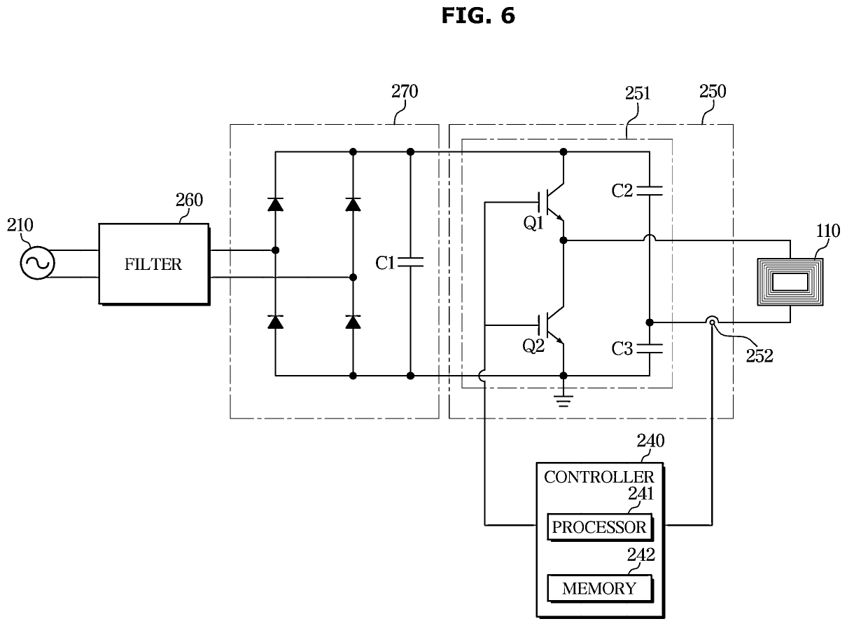

The rectifier circuit 270 may include a bridge diode. For example, the rectifier circuit 270 may include four diodes. The diodes may form diode pairs each consisting of two diodes connected in series, and two pairs of the diodes may be connected in parallel to each other. The bridge diode may convert an AC voltage whose polarity changes over time into a positive voltage with a constant polarity, and may convert an AC current whose direction changes over time into a positive current with a constant direction. For example, the rectifier circuit 270 may include a capacitor C1 (See FIG. 6) connected in parallel to at least one diode.

The power rectified by the rectifier circuit 270 may be applied to each driving circuit 250 to be transmitted to the working coil 110. An output port of the rectifier circuit 270 may be connected to the driving circuit 250. The power rectified by the rectifier circuit 270 may be transmitted to each element that requires the power such as the fan 50 and the controller 240.

The heat sink 60 may be provided to dissipate heat generated in the printed board assembly 40. For example, the heat sink 60 may prevent overheating of the rectifier circuit 270 and/or the driving circuit 250.

FIG. 6 shows an example of a cooking apparatus according to an embodiment. Like reference numerals denote like elements or components having substantially same functions, and therefore repeated descriptions thereof will be omitted.

Referring to FIG. 6, the cooking apparatus 1 according to an embodiment may include the power supply circuit 210, the filter 260, the rectifier circuit 270, the driving circuit 250, the controller 240, and the working coil 110.

The power supply circuit 210 may be provided to receive the AC power from the external power source.

The filter 260 may be provided to block high-frequency noise included in the AC power. The filter 260 may be disposed between the power supply circuit 210 and the rectifier circuit 270.

The rectifier circuit 270 may convert the AC power from which the high-frequency noise is removed into the DC power. The power rectified by the rectifier circuit 270 may be applied to the driving circuit 250. The rectifier circuit 270 may be disposed between the filter 260 and the driving circuit 250.

The driving circuit 250 may be connected to the output port of the rectifier circuit 270. The driving circuit 250 may be electrically connected to the working coil 110 to drive the working coil 110.

In FIG. 6, one driving circuit 250 and one working coil 110 connected to the driving circuit 250 are shown, but the embodiment is not limited thereto. The driving circuit 250 and the working coil 110 may be provided in plural numbers.

For example, the driving circuit 250 may include a pair of switching devices Q1 and Q2 connected in series to each other. For example, the driving circuit 250 may include a pair of resonant capacitors C2 and C3 connected in series to each other. The pair of switching devices Q1 and Q2 may be connected in parallel to the pair of resonant capacitors C2 and C3.

For example, one end of the working coil 110 may be connected to a node connected in series with the pair of switching devices Q1 and Q2. For example, the other end of the working coil 110 may be connected to a node connected in series with the pair of the resonant capacitors C2 and C3.

The pair of switching devices Q1 and Q2 may include a first switching device Q1 and a second switching device Q2. The first switching device Q1 may be closed or open under the control of the controller 240. The second switching device Q2 may be closed or open under the control of the controller 240.

A pair of resonant capacitors C2 and C3 may include a first resonant capacitor C2 and a second resonant capacitor C3. The first resonant capacitor C2 and the second resonant capacitor C3 may be connected in series between a plus line and a minus line.

By opening and closing the first switching device Q1 and the second switching device Q2, a current may flow out of the first resonant capacitor C2 and/or the second resonant capacitor C3 to the working coil 110 or flow into the first resonant capacitor C2 and/or the second resonant capacitor C3 from the working coil 110.

The inverter circuit 251 may control the current supplied to the working coil 110. By opening and closing the first switching device Q1 and the second switching device Q2 included in the inverter circuit 251, the magnitude and direction of the current flowing in the working coil 110 may vary.

For example, the controller 240 may determine the intensity of the magnetic field output from the working coil 110 by determining an opening/closing cycle of the first switching device Q1 and the second switching device Q2 in response to the output level input via the user interface 22.

The current sensing circuit 252 may measure the current output from the inverter circuit 251. The current sensing circuit 252 may sense the magnitude of the AC driving current supplied to the working coil 110.

The controller 240 may control the current sensing circuit 252 to measure the magnitude of the current supplied to the working coil 110 by the current sensing circuit 252. The controller 240 may receive information on the magnitude of the current output from the current sensing circuit 252. For example, the controller 240 may determine the presence of the cooking vessel C based on the output value of the current sensing circuit 252. For example, the controller 240 may determine whether the cooking apparatus 1 is out of order by determining whether the intended current flows in the working coil 110.

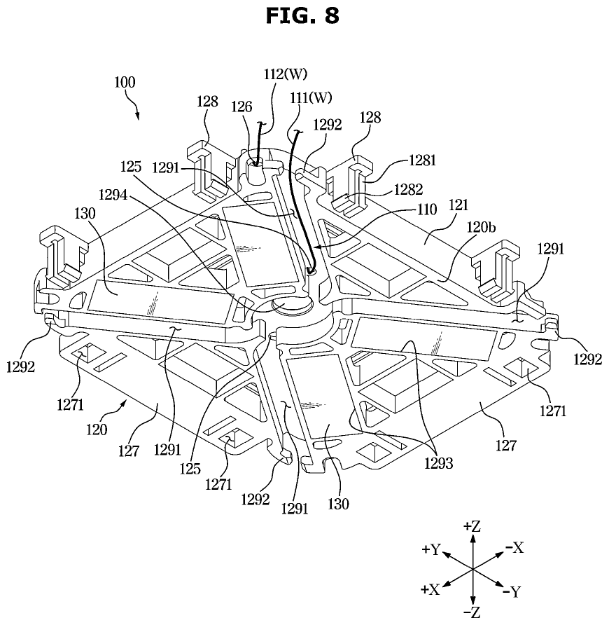

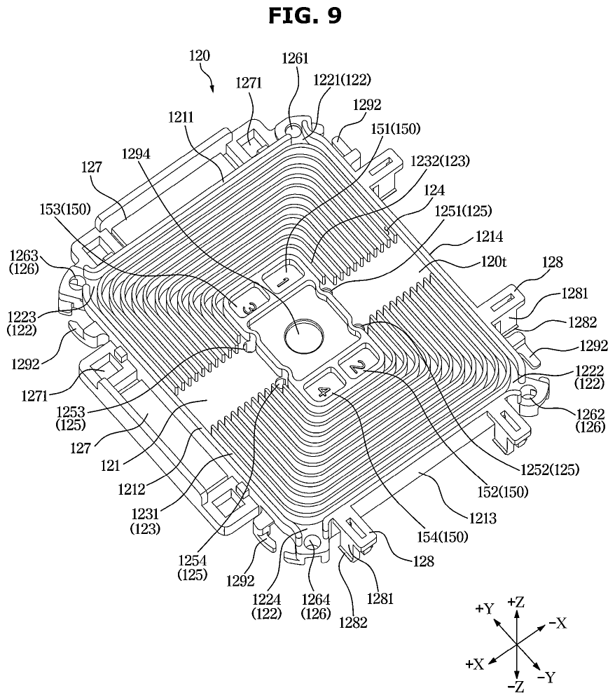

FIG. 7 is an exploded view exemplarily illustrating a coil assembly according to an embodiment. FIG. 8 is a bottom perspective view exemplarily illustrating a coil assembly according to an embodiment. FIG. 9 is a perspective view exemplarily illustrating a base according to an embodiment.

Referring to FIG. 7, a coil assembly 100 may include a working coil 110. The coil assembly 100 may include a base 120 supporting the working coil 110.

The coil assembly 100 may further include a ferrite 130. The ferrite 130 may increase density of a magnetic field generated by the working coil 110.

The ferrite 130 may be detachably installed under the base 120. For example, the ferrite 130 may be mounted on a ferrite mount 1293 of the base 120 which will be described below. For example, the ferrite 130 may be inserted into the ferrite mount 1293 of the base 120 which will be described below. The ferrite 130 may be disposed between the base 120 and the partition 70.

Although four ferrites 130 are illustrated in FIGS. 7 and 8, the embodiment is not limited thereto. For example, the number of the ferrites 130 may be 3 or less. For example, the number of the ferrites 130 may be 5 or more.

The coil assembly 100 may further include a sheet 140. The sheet 140 may be disposed above the working coil 110. However, unlike that illustrated in FIG. 7, the sheet 140 may be disposed below the base 120. In addition, unlike that illustrated in FIG. 7, the sheet 140 may be provided in a plural number.

The sheet 140 may have a shape corresponding to that of the base 120. The sheet 140 may have an approximately rectangular shape.

For example, the sheet 140 may prevent currents flowing in the working coil 110 from being transmitted to other components of the cooking apparatus 1. For example, the sheet 140 may prevent currents flowing in the working coil 110 from affecting the printed board assembly 40 and/or the main assembly 30. For example, the sheet 140 may include an electrically insulating material. For example, the sheet 140 may include a mica sheet. For example, the sheet 140 may increase electromagnetic wave shielding efficiency.

For example, the sheet 140 may prevent heat generated in the cooking vessel C from being transferred to the coil assembly 100 via the cooking plate 20. For example, the sheet 140 may be provided to prevent heat generated in the working coil 110 from being transferred to another component. For example, the sheet 140 may include an insulating material.

The working coil 110 may generate a magnetic field. The working coil 110 may generate an electromagnetic field. The working coil 110 may receive a driving current from the driving circuit 250 (See FIGS. 4 to 6). The working coil 110 may be provided to heat the cooking vessel C placed on the cooking plate 20 by induction heating.

The working coil 110 may be driven under the control of the controller 240 (See FIGS. 4 to 6). For example, the supply of the driving current to the working coil 110 and/or the intensity of the magnetic field generated in the working coil 110 may be controlled by the controller 240.

The working coil 110 may be formed of a wound wire W.

The wire W may include plurality of windings 113 constituting respective turns. For example, among the plurality of windings 113, a winding 1131 located at an innermost side of the working coil 110 may constitute the first turn of the working coil 110. For example, among the plurality of windings 113, a winding 1132 located at an outermost side of the working coil 110 may constitute the last turn of the working coil 110. For example, an nth winding among the plurality of windings 113 may constitute an nth turn.

Each of the plurality of windings 113 may be arranged to be spaced apart from an adjacent winding by a fixed interval. For example, a winding constituting the first turn may be arranged to be spaced apart from a winding 1131 constituting a second turn by a fixed interval. For example, a winding constituting an nth turn may be arranged to be spaced apart from a winding constituting an (n−1)th turn and a winding constituting an (n+1)th turn, respectively by a fixed interval. For example, each of the plurality of windings 113 may be arranged to be spaced apart from each other by a fixed interval by a plurality of ribs 123 of the base 120 which will be described below.

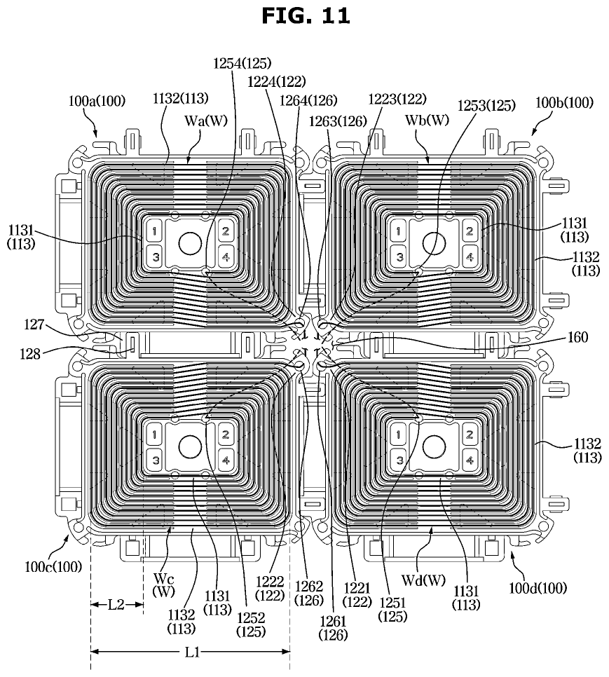

For example, a smallest distance L2 between the winding 1131 constituting the innermost turn among the plurality of windings 113 and the winding 1132 constituting the outermost turn among the plurality of windings 113 may be approximately ⅓ or less of the length L1 of the long side of the working coil 100 (See FIG. 11).

For example, the wire W may be provided as a Litz wire manufactured by twisting multistrands of copper thin wire, individually having an insulating coating layer.

For example, the wire W may be wound to correspond to the shape of the base 120. For example, the wire W may be wound to have a rectangular shape. For example, the wire W may be provided to be withdrawn toward a corner of the base 120. This will be described in more detail below.

Opposite ends of the working coil 110 may be connected to the printed board assembly 40, respectively. The opposite ends of the working coil 110 may be connected to the driving circuit 250. The working coil 110 may be electrically connected to the driving circuit 250 to receive a driving current. For example, one end of the working coil 110 may be connected between the first switching device Q1 and the second switching device Q2 (See FIG. 6). For example, the other end of the working coil 110 may be connected between the first resonant capacitor C2 and the second resonant capacitor C3 (See FIG. 6).

Referring to FIGS. 7 to 9, the coil assembly 100 may include a base 120. The base 120 may be provided to support the working coil 110. The base 120 may be disposed under the working coil 110. For example, the working coil 110 may be seated on the top surface 120t of the base 120.

For example, the base 120 may have an approximately rectangular shape. For example, each corner 122 of the base 120 may have an arc shape. For example, the base 120 may have a rectangular shape with rounded corners. Thus, in the case where a plurality of coil assemblies 100 constitute one cooking zone, a communicating portion 160, which will be described below, may be formed.

The base 120 may include a base body 121. The working coil 110 may be seated on the base body 121. The base body 121 may have an approximately flat-panel shape. The base body 121 may be provided to have an approximately rectangular shape. The base body 121 may be provided to have a rectangular shape with rounded corners.

For example, the base body 121 may have four sides 1211, 1212, 1213, and 1214. A first side 1211 of the base body 121 may be provided to be approximately perpendicular to a second side 1212 of the base body 121. A third side 1213 of the base body 121 may be provided to be approximately perpendicular to a fourth side 1214 of the base body 121. The first side 1211 and the third side 1213 may be provided to face each other. The second side 1212 and the fourth side 1214 may be provided to face each other.

For example, referring to FIG. 9, the first side 1211 may be defined as the left side of the base body 121, the second side 1212 may be defined as the front side of the base body 121, the third side 1213 may be defined as the right side of the base body 121, and the fourth side 1214 may be defined as the rear side of the base body 121.

However, this is merely an example based on the drawings for descriptive convenience, and each of the four sides 1211, 1212, 1213, and 1214 of the base body 121 may refer to other sides different from the above-described sides.

The base 120 may include corners 122. For example, the base 120 having a rectangular shape may have four corners 122.

For example, the base 120 may include a first corner 1221 disposed between the first side 1211 and the fourth side 1214. For example, the first corner 1221 may be a rear left corner of the base 120.

For example, the base 120 may include a second corner 1222 disposed between the fourth side 1214 and the third side 1213. For example, the second corner 1222 may be a rear right corner of the base 120.

For example, the base 120 may include a third corner 1223 disposed between the first side 1211 and the second side 1212. For example, the third corner 1223 may be a front left corner of the base 120.

For example, the base 120 may include a fourth corner 1224 disposed between the second side 1212 and the third side 1213. For example, the fourth corner 1224 may be a front right corner of the base 120.

However, the definitions described above are merely examples based on the drawings for descriptive convenience. Each corner 122 of the base 120 may refer other corners different from the above-described corners.

The wire W of the working coil 110 may be withdrawn toward one corner of the base 120. The wire W of the working coil 110 may be withdrawn through one of the four corners 122 of the base 120. This will be described below in more detail.

The base 120 may include a plurality of ribs 123. The wire W forming the working coil 110 may be provided to be wound multiple times by the plurality of ribs 123.

The plurality of ribs 123 may be provided to separate a plurality of windings 113 of the working coil 110. The plurality of ribs 123 may allow the plurality of windings 113 of the working coil 110 to be spaced apart from each other.

The plurality of ribs 123 may be disposed on the top surface 120t of the base 120. The plurality of ribs 123 may protrude upward from the base body 121. The plurality of ribs 123 may have a shape extending along edges of the base body 121. For example, the plurality of ribs 123 may extend to a predetermined extent to have a rectangular shape. For example, the plurality of ribs 123 may be provided to have a rectangular frame shape. In the drawings, the plurality of ribs 123 having an intermittent rectangular frame shape are illustrated, but the embodiment is not limited thereto. The plurality of ribs 123 may also be provided to a continuous rectangular frame shape.

The base 120 may have a plurality of grooves 124. The plurality of grooves 124 may be formed between ribs adjacent to each other among the plurality of ribs 123. The plurality of grooves 124 may have a shape relatively recessed because the plurality of ribs 123 protrude upward. Each of the plurality of windings 113 may be disposed in each of the plurality of grooves 124.

The base 120 may have an insertion opening 125. The insertion opening 125 may be formed in the base body 121. The insertion opening 125 may be formed at an inner area of the base body 121. The insertion opening 125 may penetrate the base body 121.

At least a part of the wire W of the working coil 110 may pass through the insertion opening 125 and wound on the top surface 120t of the base 120. At least a part of the wire W of the working coil 110 may penetrate from the bottom surface 120b of the base 120 to the top surface 120t, and then be wound on the top surface 120t of the base 120.

The insertion opening 125 may be provided to be adjacent to the innermost turn of the wire W in a state where the working coil 110 is supported by the base 120. The insertion opening 125 may be provided to be adjacent to the winding 1131 among the plurality of windings 113. The insertion opening 125 may be provided to be adjacent to the innermost rib 1231 among the plurality of ribs 123.

The insertion opening 125 may be provided to correspond to each corner 122 of the base 120. For example, four insertion openings 125 may be provided.

For example, the base 120 may have a first insertion opening 1251 corresponding to the first corner 1221 in an approximately diagonal direction. For example, the base 120 may have a second insertion opening 1252 corresponding to the second corner 1222 in an approximately diagonal direction. For example, the base 120 may have a third insertion opening 1253 corresponding to the third corner 1223 in an approximately diagonal direction. For example, the base 120 may have a fourth insertion opening 1254 corresponding to the fourth corner 1224 in an approximately diagonal direction.

The base 120 may have a withdrawal opening 126. The withdrawal opening 126 may be formed at each corner 122 of the base 120. For example, the withdrawal opening 126 may be formed at a corner body 122a protruding from each corner of the base body 121. For example, the withdrawal opening 126 may penetrate the corner body 122a.

The wire W of the working coil 110 may be withdrawn from the base 120 through the withdrawal opening 126. The wire W of the working coil 110 may be guided by the withdrawal opening 126 and withdrawn from the corner of the base 120. The wire W of the working coil 110 may be connected to the driving circuit 250 after passing through the withdrawal opening 126.

For example, one end of the wire W partially wound may pass through the withdrawal opening 126 to be connected to the printed board assembly 40. For example, the one end of the wire W partially wound may pass through the withdrawal opening 126 to be connected to the driving circuit 250.

The withdrawal opening 126 may be provided to be adjacent to the outermost turn of the wire W in a state where the working coil 110 is supported by the base 120. The withdrawal opening 126 may be provided to be adjacent to the winding 1132 among the plurality of windings 113. The withdrawal opening 126 may be provided to be adjacent to the outermost rib 1232 among the plurality of ribs 123.

The withdrawal opening 126 may be formed at each corner 122 of the base 120. For example, four withdrawal openings 126 may be provided.

For example, the base 120 may have a first withdrawal opening 1261 provided at the first corner 1221. The base 120 may have a second withdrawal opening 1262 provided at the second corner 1222. The base 120 may have a third withdrawal opening 1263 provided at the third corner 1223. The base 120 may have a fourth withdrawal opening 1264 provided at the fourth corner 1224.

For example, the wire W of the working coil 110 may be provided to pass through one of the four insertion openings 1251, 1252, 1253, and 1254 and a withdrawal opening closest to the insertion opening, among the four withdrawal openings 1261, 1262, 1263, and 1264. For example, the wire W of the working coil 110 may pass through the first insertion opening 1251, be wound on the base 120, and then be withdrawn through the first withdrawal opening 1261. For example, the wire W of the working coil 110 may pass through the second insertion opening 1252, be wound on the base 120, and then be withdrawn through the second withdrawal opening 1262. For example, the wire W of the working coil 110 may pass through the third insertion opening 1253, be wound on the base 120, and then be withdrawn through the third withdrawal opening 1263. For example, the wire W of the working coil 110 may pass through the fourth insertion opening 1254, be wound on the base 120, and then be withdrawn through the fourth withdrawal opening 1264.

Due to this structure, the wire W may be easily inserted into and/or withdrawn from the base 120. The user may easily identify the direction of the wire W of the coil assembly 100. The user may easily arrange the wire W of the coil assembly 100. Issues such as incorrect connection of the wire W to the printed board assembly 40 may be prevented in advance. A time consumed in connecting the wire W may be reduced. Furthermore, in the case where the at least one coil assembly 100 is provided in a plural number, wire interference between the plurality of coil assemblies 100 may be minimized.

The insertion opening 125 may be referred to as a first opening 125, and the withdrawal opening 126 may be referred to as a second opening 126. However, the configuration of the first opening 125 and the second opening 126 is not limited by the ordinal numbers of “first” and “second”. For example, the openings may also be referred inversely as the second opening 125 and the first opening 126.

The base 120 may include an identifier 150. The user may easily identify an insertion direction of the wire W and/or a withdrawal direction of the wire W via the identifier 150. For example, in the case where the at least one coil assembly 100 is provided in a plural number, the identifier 150 may be easily used in designing the withdrawal direction of each of the wires of the plurality of coil assemblies.

For example, the identifier 150 may include a first identifier 151. The user may recognize, by the first identifier 151, that the wire W of the working coil 110 should pass through the first insertion opening 1251 to be withdrawn through the first withdrawal opening 1261.

For example, the identifier 150 may include a second identifier 152. The user may recognize, by the second identifier 152, that the wire W of the working coil 110 should pass through the second insertion opening 1252 to be withdrawn through the second withdrawal opening 1262.

For example, the identifier 150 may include a third identifier 153. The user may recognize, by the third identifier 153, that the wire W of the working coil 110 should pass through the third insertion opening 1253 to be withdrawn through the third withdrawal opening 1263.

For example, the identifier 150 may include a fourth identifier 154. The user may recognize, by the fourth identifier 154, that the wire W of the working coil 110 should pass through the fourth insertion opening 1254 to be withdrawn through the fourth withdrawal opening 1264.

For example, the identifier 150 may be provided by numbering the insertion openings 125 into which the wire W is inserted and the withdrawal openings 126 through which the wire W is withdrawn. However, the embodiment is not limited thereto, and the identifier 150 may indicate the insertion openings 125 into which the wire W is inserted and the withdrawal openings 126 through which the wire W is withdrawn by various known methods.

Meanwhile, the wire W of the working coil 110 may be inserted into the base 120 after passing through the first opening 125 of the base 120. The wire W having passed through the first opening 125 of the base 120 may partially be wound on the base 120. The wire W partially wound on the base 120 may be withdrawn from the base 120 after passing through the second opening 126 of the base 120.

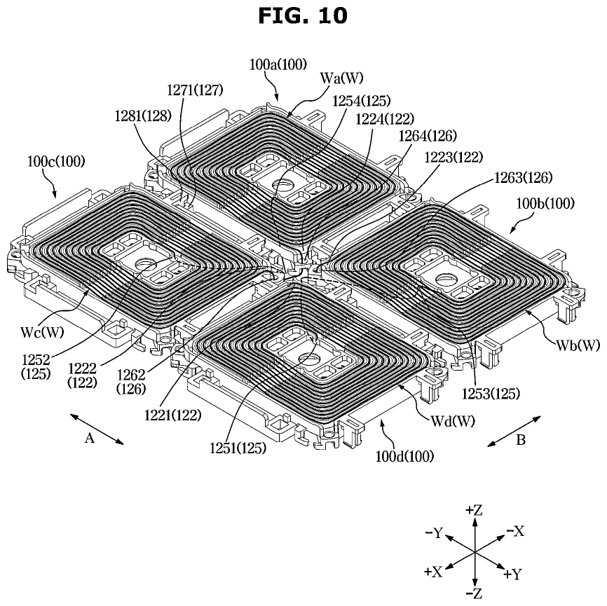

For example, referring to FIG. 8, the wire W may include a first wire section 111 (See FIG. 8 and dashed lines of FIGS. 10 to 12) below of the base 120 and extending toward the first opening 125. The first wire section 111 may refer to a part of the wire W inserted into the base 120.

For example, referring to FIG. 8, the wire W may include a second wire section 112 (See FIG. 8 and solid lines of FIGS. 10 to 12) extending from the first wire section 111 and passing through the first opening 125 to be seated on the base 120. The second wire section 112 may refer to a part of the wire W wound on the base 120 and be withdrawn from the base 120. The second wire section 112 may include a plurality of windings 113.

The base 120 may have a guide groove 1291. The guide groove 1291 may be provided to guide the first wire section 111. The guide groove 1291 may be formed in the bottom surface 120b of the base 120. The guide groove 1291 may be formed radially in the bottom surface 120b of the base 120. The guide groove 1291 may be formed to be recessed from the bottom surface 120b of the base 120.

The guide groove 1291 may extend between the first opening 125 and the corner 122. For example, four guide grooves 1291 may be provided.

The base 120 may include a holder 1292. The holder 1292 may be provided to fix the first wire section 111. After passing through the holder 1292, the first wire section 111 may be guided by the guide groove 1291 to extend to the first opening 125.

The holder 1292 may be arranged to be adjacent to the guide groove 1291. The holder 1292 may be disposed adjacent to each corner 122 of the base 120. The holder 1292 may be disposed adjacent to the second opening 126. For example, four holders 1292 may be provided.

The base 120 may include a ferrite mount 1293 on which the ferrite 130 is mounted. The ferrite mount 1293 may be formed on the bottom surface 120b of the base 120. The ferrite mount 1293 may be formed to be recessed from the bottom surface 120b of the base 120. The ferrite mount 1293 may have a shape corresponding to the ferrite 130. The ferrite mount 1293 may be provided in the same number as the number of the ferrite 130.

Although four ferrite mounts 1293 are illustrated in the drawings, the embodiment is not limited thereto. For example, the number of the ferrite mount 1293 may be 3 or less. For example, the number of the ferrite mount 1293 may be 5 or more.

The base 120 may include a sensor mount 1294. The sensor mount 1294 may be provided with at least one sensor configured to detect various information detectors of the cooking apparatus 1. For example, the sensor mount 1294 may be provided at the center of the base 120. For example, a vessel sensor 221 may be detachably mounted on the sensor mount 1294. For example, a first temperature sensor 231 may be detachably mounted on the sensor mount 1294.

Referring to FIG. 9, the base 120 may include a first coupler 127. The first coupler 127 may be formed at each of the first side 1211 of the base body 121 and the second side 1212 of the base body 121. The first side 1211 of the base body 121 may be provided to be perpendicular to the second side 1212 of the base body 121.

For example, the first coupler 127 may have a coupling hole 1271.

Referring to FIG. 9, the base 120 may include a second coupler 128. The second coupler 128 may be formed at each of the third side 1213 of the base body 121 and the fourth side 1214 of the base body 121. The third side 1213 of the base body 121 may be provided to face the first side 1211 of the base body 121. The fourth side 1214 of the base body 121 may be provided to face the second side 1212 of the base body 121.

For example, the second coupler 128 may include a coupling protrusion 1281. The coupling protrusion 1281 may have a shape protruding downward. For example, the second coupler 128 may have a fastener 1282 formed at the end of the coupling protrusion 1281.

In the case where the coil assembly is provided in a plural number, coil assemblies adjacent to each other may be provided to be coupleable to each other. For example, in the case where the coil assembly consists of the first coil assembly and the second coil assembly, the first coupler 127 of the first coil assembly may be provided to be coupleable to the second coupler 128 of the second coil assembly. For example, in the case where the coil assembly consists of the first coil assembly and the second coil assembly, the second coupler 128 of the first coil assembly may be coupleable to the first coupler 127 of the second coil assembly.

For example, the coupling protrusion 1281 of the first coil assembly may be provided to be inserted into the coupling hole 1271 of the second coil assembly. The coupling protrusion 1281 of the second coil assembly may be provided to be inserted into the coupling hole 1271 of the first coil assembly. In a state where the coupling protrusion 1281 is inserted into the coupling hole 1271, the fastener 1282 of the second coupler 128 may be provided to be held by the first coupler 127. Thus, separation of the first coupler 127 form the second coupler 128 may be prevented.

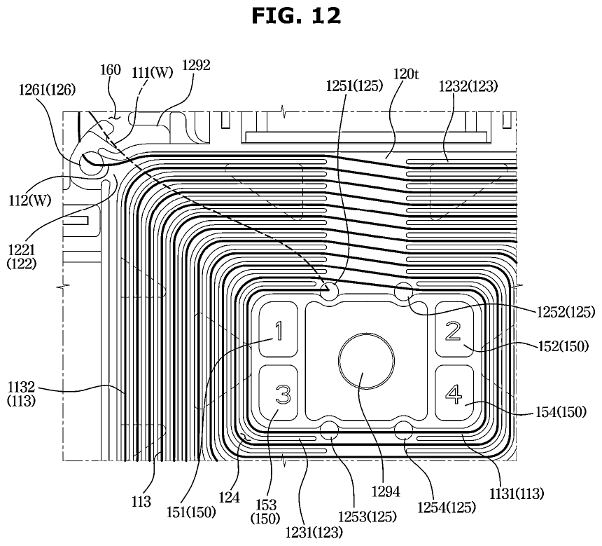

FIG. 10 is a perspective view illustrating an example of a plurality of coil assemblies according to an embodiment. FIG. 11 is a plan view of an example of a plurality of coil assemblies according to an embodiment. FIG. 12 is a partially exploded view of FIG. 11. Like reference numerals are used to represent parts or elements performing substantially same functions, and repeated description of such elements may be omitted. The coil assembly 100 described in FIGS. 7 to 9 may correspond to each of the plurality of coil assemblies which will be described with reference to FIGS. 10 to 12.

Referring to FIGS. 10 and 11, at least one coil assembly 100 may be provided in a plural number.

For example, the plurality of coil assemblies 100 may include a first coil assembly 100a, a second coil assembly 100b, a third coil assembly 100c, and a fourth coil assembly 100d.

For example, the second coil assembly 100b may be detachably coupled to the first coil assembly 100a in a first direction A. For example, the second coil assembly 100b may be arranged at the third side 1213 of the first coil assembly 100a. For example, the second coil assembly 100b may be disposed at the right side of the first coil assembly 100a.

For example, the third coil assembly 100c may be detachably coupled to the first coil assembly 100a in a second direction B. For example, the third coil assembly 100c may be arranged at the second side 1212 of the first coil assembly 100a. For example, the third coil assembly 100c may be disposed at the front side of the first coil assembly 100a.

For example, the fourth coil assembly 100d may be detachably coupled to the second coil assembly 100b in the second direction B. For example, the fourth coil assembly 100d may be arranged at the second side 1212 of the second coil assembly 100b. For example, the fourth coil assembly 100d may be disposed at the front side of the second coil assembly 100b.

For example, the fourth coil assembly 100d may be detachably coupled to the third coil assembly 100c in the first direction A. For example, the fourth coil assembly 100d may be arranged at the third side 1213 of the third coil assembly 100c. For example, the fourth coil assembly 100d may be disposed at the right side of the third coil assembly 100c.

In the drawings, the first direction A refers to the left-right direction Y, and the second direction B refers to the front-back direction X, but the embodiment is not limited thereto. The indication of the first direction A and the second direction B are merely for the convenience of description of the plurality of coil assemblies 100.

The second coupler 128 of the first coil assembly 100a may be detachably coupled to the first coupler 127 of the second coil assembly 100b. The first coupler 127 of the first coil assembly 100a may be detachably coupled to the second coupler 128 of the third coil assembly 100c.

The first coupler 127 of the second coil assembly 100b may be detachably coupled to the second coupler 128 of the first coil assembly 100a. The first coupler 127 of the second coil assembly 100b may be detachably coupled to the second coupler 128 of the fourth coil assembly 100d.

The second coupler 128 of the third coil assembly 100c may be detachably coupled to the first coupler 127 of the first coil assembly 100a. The second coupler 128 of the third coil assembly 100c may be detachably coupled to the first coupler 127 of the fourth coil assembly 100d.

The first coupler 127 of the fourth coil assembly 100d may be detachably coupled to the second coupler 128 of the third coil assembly 100c. The second coupler 128 of the fourth coil assembly 100d may be detachably coupled to the first coupler 127 of the second coil assembly 100b.

For example, four adjacent coil assemblies 100a, 100b, 100c, and 100d may constitute one heating unit. For example, a heating unit formed of four coil assemblies 100a, 100b, 100c, and 100d may have an approximately rectangular shape.

The plurality of coil assemblies 100a, 100b, 100c, and 100d may constitute a communicating portion 160. For example, the communicating portion 160 may be provided at an approximately center of a combined structure of the plurality of coil assemblies 100a, 100b, 100c, and 100d. For example, the communicating portion 160 may be a space surrounded by the first coil assembly 100a, the second coil assembly 100b, the third coil assembly 100c, and the fourth coil assembly 100d. For example, the communicating portion 160 may be a space surrounded by the fourth corner 1224 of the first coil assembly 100a, the third corner 1223 of the second coil assembly 100b, the second corner 1222 of the third coil assembly 100c, and the first corner 1221 of the fourth coil assembly 100d. The wires Wa, Wb, Wc, and Wd of the plurality of coil assemblies may pass through the communicating portion 160 to be connected to the printed board assembly 40. The wires Wa, Wb, Wc, and Wd of the plurality of coil assemblies may pass through the communicating portion 160 to be connected to the driving circuit 250. The wires Wa, Wb, Wc, and Wd of the plurality of coil assemblies may be connected to the printed board assembly 40 after passing through the communicating portion 160 and partition hole 71. As a result, the wires Wa, Wb, Wc, and Wd of the plurality of coil assemblies may be arranged to gather approximately at the center toward the communicating portion 160.

The wire Wa of the first coil assembly 100a may pass through the fourth insertion opening 1254 of the first coil assembly 100a and be wound on the base 120. The wire Wa of the first coil assembly 100a may be withdrawn via a corner facing the fourth coil assembly 100d. The wire Wa of the first coil assembly 100a may be withdrawn through the fourth corner 1224. The wire Wa of the first coil assembly 100a may pass through the fourth withdrawal opening 1264.

The wire Wb of the second coil assembly 100b may pass through the third insertion opening 1253 of the second coil assembly 100b and be wound on the base 120. The wire Wb of the second coil assembly 100b may be withdrawn via a corner facing the third coil assembly 100c. The wire Wb of the second coil assembly 100b may be withdrawn via the third corner 1223. The wire Wb of the second coil assembly 100b may pass through the third withdrawal opening 1263.

The wire Wc of the third coil assembly 100c may pass through the second insertion opening 1252 of the third coil assembly 100c and be wound on the base 120. The wire Wc of the third coil assembly 100c may be withdrawn via a corner facing the second coil assembly 100b. The wire Wc of the third coil assembly 100c may be withdrawn via the second corner 1222. The wire Wc of the third coil assembly 100c may pass through the second withdrawal opening 1262.

The wire Wd of the fourth coil assembly 100d may pass through the first insertion opening 1251 of the fourth coil assembly 100d and be wound on the base 120. The wire Wd of the fourth coil assembly 100d may be withdrawn via a corner facing the first coil assembly 100a. The wire Wd of the fourth coil assembly 100d may be withdrawn via the first corner 1221. The wire Wd of the fourth coil assembly 100d may pass through the first withdrawal opening 1261.

In general, in the case where the plurality of coil assemblies are provided to constitute one cooking zone, the wires of the plurality of coil assemblies may interfere with each other. As a result, it may be difficult to connect wires of the plurality of coil assemblies the printed board assembly. Accordingly, a predetermined gap may be required between the plurality of coil assemblies to withdraw the wires while avoiding interference. However, the cooking apparatus becomes larger by forming the gap. In addition, it may be difficult to utilize an area where the gap is formed as a cooking space.

On the contrary, according to an embodiment of the present disclosure, each of the plurality of coil assemblies 100a, 100b, 100c, and 100d has a rectangular shape, and each of the wires Wa, Wb, Wc, and Wd of the plurality of coil assemblies 100a, 100b, 100c, and 100d may be withdrawn via each corner. For example, as described above, each of the wires Wa, Wb, Wc, and Wd of the plurality of coil assemblies 100a, 100b, 100c, and 100d may be provided to gather at the center by the communicating portion 160. As a result, connection of the wires Wa, Wb, Wc, and Wd with the printed board assembly becomes easier. In addition, the distance between the plurality of coil assemblies may be minimized and a cooking area of the cooking apparatus may be easily obtained. For example, the cooking area may be maximized in the entire area of the cooking plate 20. As a result, plurality of coil assemblies may be compactly arranged and the cooking apparatus 1 becomes smaller in size.

Although the embodiments of the present disclosure have been provided for illustrative purposes, the scope of the present disclosure is limited thereto. Various embodiments that may be modified and altered by those skilled in the art without departing from the principles and spirit of the present disclosure, the scope of which is defined in the claims, should be construed as falling within the scope of the present disclosure.

1. A cooking apparatus comprising:
a cooking plate;
at least one coil assembly, arrangeable below the cooking plate, configured to generate a magnetic field; and
a driving circuit configured to drive the at least one coil assembly while the at least one coil assembly is arranged below the cooking plate,
wherein the at least one coil assembly comprises:
a base with a rectangular shape; and
a working coil, supportable by the base, formed of a wire wound to correspond to the rectangular shape of the base, wherein while the working coil is supported by the base, the wire is withdrawable toward a corner of the base.

2. The cooking apparatus according to claim 1, wherein
the wire comprises a plurality of windings constituting respective turns, and
the base includes:
a first opening adjacent to an innermost turn of the wire while the working coil is supported by the base; and
a second opening, adjacent to an outermost turn of the wire while the working coil is supported by the base, formed at one corner of the base.

3. The cooking apparatus according to claim 2, wherein the wire passes through the first opening of the base to be wound on a top surface of the base and passes through the second opening of the base to be connected to the driving circuit.

4. The cooking apparatus according to claim 2, wherein the second opening is formed at each corner of the base.

5. The cooking apparatus according to claim 1, wherein the base comprises:
a base body on which the working coil is seated so as to be supported by the base;
a first coupler formed both at a first side of the base body and a second side of the base body perpendicular to the first side; and
a second coupler formed both at a third side of the base body facing the first side and a fourth side of the base body facing the second side.

6. The cooking apparatus according to claim 5, wherein the at least one coil assembly is a first coil assembly and the cooking apparatus includes a second coil assembly arrangeable adjacent to the first coil assembly, and
the first coupler of the first coil assembly is coupleable to the second coupler of the second coil assembly.

7. The cooking apparatus according to claim 5, wherein the at least one coil assembly is a first coil assembly and the cooking apparatus includes a second coil assembly arrangeable adjacent to the first coil assembly, and
the second coupler of the first coil assembly is coupleable to the first coupler of the second coil assembly.

8. The cooking apparatus according to claim 6 or claim 7, wherein
the first coupler includes a coupling hole, and
the second coupler includes a coupling protrusion insertable into the coupling hole.

9. The cooking apparatus according to claim 2, wherein the wire comprises:
a first wire section below of the base and extending toward the first opening; and
a second wire section extending from the first wire section and passing through the first opening to be supported by the base,
wherein the base further comprises a guide groove radially formed on a bottom surface of the base to guide the first wire section.

10. The cooking apparatus according to claim 9, wherein
the base further comprises a holder arrangeable adjacent to the guide groove and provided to fix the first wire section.

11. The cooking apparatus according to claim 1, wherein the at least one coil assembly is among a plurality of coil assemblies,
the plurality of coil assemblies comprise a first coil assembly, a second coil assembly coupleable to the first coil assembly in a first direction, a third coil assembly coupleable to the first coil assembly in a second direction, a fourth coil assembly coupleable to the second coil assembly in the second direction and coupleable to the third coil assembly in the first direction,
wherein the wire of the first coil assembly is withdrawn via a corner facing the fourth coil assembly,
the wire of the second coil assembly is withdrawn via a corner facing the third coil assembly,
the wire of the third coil assembly is withdrawn via a corner facing the second coil assembly, and
the wire of the fourth coil assembly is withdrawn via a corner facing the first coil assembly.

12. The cooking apparatus according to claim 1, wherein each corner of the base has an arc shape.

13. The cooking apparatus according to claim 1, wherein the wire forms a plurality of windings constituting respective turns, and
the base comprises:
a base body on which the working coil is seated;
a plurality of ribs protruding upward from the base body and extending along edges of the base body to separate the plurality of windings from each other; and
a plurality of grooves formed between adjacent ribs among the plurality of ribs.

14. The cooking apparatus according to claim 1, further comprising a ferrite mountable under a bottom of the base to increase a density of the magnetic field generated by the working coil.

15. The cooking apparatus according to claim 1, wherein the at least one coil assembly further comprises a sheet arrangeable above the working coil, having a shape corresponding to the base, and formed of an electrically insulating material.
